(19) United States
(12) Patent Application Publication
(10) Pub. No.: US 2020/0326193 A1
(43) Pub. Date: Oct. 15, 2020

(54) INFORMATION PROCESSING APPARATUS, NOTIFICATION METHOD, AND NON-TRANSITORY COMPUTER READABLE MEDIUM

(71) Applicant: NEC Corporation, Tokyo (JP)

(72) Inventors: Shigeki SHINODA, Tokyo (JP); Akane ARUGA, Tokyo (JP); Takumi OTANI, Tokyo (JP); Ikumi SAGA, Tokyo (JP); Yuzo SENDA, Tokyo (JP)

(73) Assignee: NEC Corporation, Tokyo (JP)

(21) Appl. No.: 16/847,891

(22) Filed: Apr. 14, 2020

(30) Foreign Application Priority Data
Apr. 15, 2019 (JP) 2019-077068

(51) Int. Cl. G01C 21/34; G06Q 10/02; H04W 68/00

(52) U.S. Cl. CPC G01C 21/3423; G01C 21/343; H04W 68/005; G06Q 10/02; G01C 21/3461

(57) ABSTRACT

The present disclosure provides an information processing apparatus, a notification method, and a non-transitory computer readable medium that can contribute to relief from congestion in an airport facility. The information processing apparatus includes: an acquisition unit configured to acquire a position of a user and reservation information of an aircraft which the user plans to board; a calculation unit configured to calculate, based on the reservation information, a travel time including a spare time for a scheduled boarding time of the aircraft corresponding to a mode of transportation and a travel route from the position to a scheduled boarding place of the aircraft; and a notification unit configured to notify the user of the travel time corresponding to the mode of transportation and the travel route.

### INCORPORATION BY REFERENCE

This application is based upon and claims the benefit of priority from Japanese patent application No. 2019-077068, filed on Apr. 15, 2019, the disclosure of which is incorporated herein in its entirety by reference.

### TECHNICAL FIELD

The present disclosure relates to an information processing apparatus, a notification method, and a computer readable medium.

### BACKGROUND ART

In order to relieve congestion in an airport facility and improve the service thereof, for example, security checkpoint congestion degree information has been provided. The security checkpoint congestion degree information is provided for relieving congestion at the security checkpoint by having the same number of people perform each of the procedures at the security checkpoint.

In order to relieve congestion in the airport facility such as at the security checkpoint, it is necessary for a user of the airport planning to board an aircraft to arrive at the airport early and take flexible actions in accordance with the congestion situation in the airport facility. However, a user who uses the airport commonly do not like to arrive at the airport earlier than necessary, so that it is difficult to relieve congestion in the airport facility.

It should be noted that a technique for estimating a departure time that will enable a user to arrive at a destination by a desired time of arrival with time to spare is known (e.g., Japanese Unexamined Patent Application Publication No. 2013-156135). Japanese Unexamined Patent Application Publication No. 2013-156135discloses a technique for estimating a departure time while the time variation in each section between the departure place and the destination is taken into consideration.

There are a plurality of travel routes and modes of transportation which a user can use when he/she travels to the airport. The technique disclosed in Japanese Unexamined Patent Application Publication No. 2013-156135 does not take modes of transportation other than an automobile into consideration. Accordingly, when a user uses a mode of transportation other than an automobile, the user may not arrive at the airport with time to spare. Thus, when a user uses a mode of transportation other than an automobile, he/she cannot take flexible actions in accordance with the congestion situation in the airport facility. That is, using the technique disclosed in Japanese Unexamined Patent Application Publication No. 2013-156135 may not lead to relief from congestion in the airport facility.

### SUMMARY

One of the objects of the present disclosure is to solve the above-described problem, and to provide an information processing apparatus, a notification method, and a computer readable medium that can contribute to relief from congestion in an airport facility.

An information processing apparatus according to the present disclosure includes:

an acquisition unit configured to acquire a position of a user and reservation information of an aircraft which the user plans to board;

a calculation unit configured to calculate, based on the reservation information, a travel time including a spare time for a scheduled boarding time of the aircraft corresponding to a mode of transportation and a travel route from the position to a scheduled boarding place of the aircraft; and

a notification unit configured to notify the user of the travel time corresponding to the mode of transportation and the travel route.

A notification method according to the present disclosure includes:

acquiring a position of a user and reservation information of an aircraft which the user plans to board;

calculating, based on the reservation information, a travel time including a spare time for a scheduled boarding time of the aircraft corresponding to transportation and a travel route from the position to a scheduled boarding place of the aircraft; and

notifying the user of the travel time corresponding to the mode of transportation and the travel route.

A non-transitory computer readable medium storing a program according to the present disclosure is a non-transitory computer readable medium storing a program for causing a computer to:

acquire a position of a user and reservation information of an aircraft which the user plans to board;

calculate, based on the reservation information, a travel time including a spare time for a scheduled boarding time of the aircraft corresponding to a mode of transportation and a travel route from the position to a scheduled boarding place of the aircraft; and

notify the user of the travel time corresponding to the mode of transportation and the travel route.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram of an information processing apparatus according to a first example embodiment;

FIG. 2 is a diagram showing a configuration example of an information processing apparatus according to a second example embodiment;

FIG. 3 is a diagram showing an example of a travel route information table;

FIG. 4A is a diagram showing calculation processing for calculating a spare time;

FIG. 4B is a diagram showing calculation processing for calculating a spare time;

FIG. 4C is a diagram showing calculation processing for calculating a spare time;

FIG. 5 is a diagram showing an example of a travel time table;

FIG. 6 is a diagram showing an operation example of the information processing apparatus according to the second example embodiment;

FIG. 7 is a diagram showing a configuration example of an information processing apparatus according to a third example embodiment;

FIG. 8 is a diagram showing an example of an action history table;

FIG. 9 is a diagram showing an operation example of the information processing apparatus according to the third example embodiment;

FIG. 10 is a diagram showing a configuration example of an information processing apparatus according to a fourth example embodiment;

FIG. 11 is a diagram for explaining an outline of an operation example of the information processing apparatus according to the fourth example embodiment;

FIG. 12 is a flowchart showing an operation example of the information processing apparatus according to the fourth example embodiment; and

FIG. 13 is a block diagram showing a hardware configuration of the information processing apparatus and the like according to the example embodiments of the present disclosure.

### EMBODIMENTS

Hereinafter, with reference to the drawings, example embodiments of the present disclosure will be described. Note that for the clarification of the description, the following description and drawings are omitted or simplified as appropriate. Further, throughout the following drawings, the same components are denoted by the same reference signs and repeated descriptions will be omitted as appropriate.

### First Example Embodiment

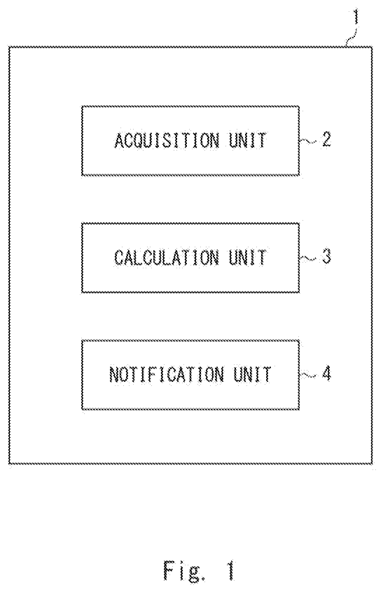

An information processing apparatus 1 according to a first example embodiment is described with reference to FIG. 1. FIG. 1 is a diagram of the information processing apparatus according to the first example embodiment. The information processing apparatus 1 includes an acquisition unit 2, a calculation unit 3, and a notification unit 4.

The acquisition unit 2 acquires the position of a user and reservation information of the aircraft which the user plans to board.

The calculation unit 3 calculates, based on the reservation information, a travel time including a spare time corresponding to the travel route and the mode of transportation from the position acquired by the acquisition unit 2 to the scheduled boarding place of the aircraft which a user plans to board.

The travel time includes a required travel time indicating a travel time that is required from the position acquired by the acquisition unit 2 to the scheduled boarding place, and the spare time. The required travel time may include a procedure time that is required for procedures required before arrival at the scheduled boarding place. The scheduled boarding place may be a predetermined position in the boarding area of the airport or may be a boarding gate of the aircraft which a user plans to board.

The spare time is a spare time for the scheduled boarding time of the aircraft which a user plans to board, and is a time between an arrival time in a case where a user arrives at the scheduled boarding place without delay when the user travels a travel route to be used by a mode of transportation to be used, and a scheduled boarding time of the aircraft which the user plans to board.

The notification unit 4 notifies a user of the travel time corresponding to the travel route and the mode of transportation, which is calculated by the calculation unit 3.

The information processing apparatus 1 has the aforementioned configuration, and thus can calculate a travel time in which a spare time corresponding to a travel route and a mode of transportation which a user can use is taken into consideration. Accordingly, a user can arrive at the airport with time to spare no matter which travel route and mode of transportation the user uses and take flexible actions in accordance with the congestion situation in the airport facility. Thus, the information processing apparatus 1 according to the first example embodiment enables a user to take flexible actions in accordance with the congestion situation in an airport facility, thereby contributing to relief from the congestion in the airport facility.

### Second Example Embodiment

Next, a second example embodiment is described. The second example embodiment is an example embodiment in which the first example embodiment is specifically described.

<Configuration Example of Information Processing Apparatus>

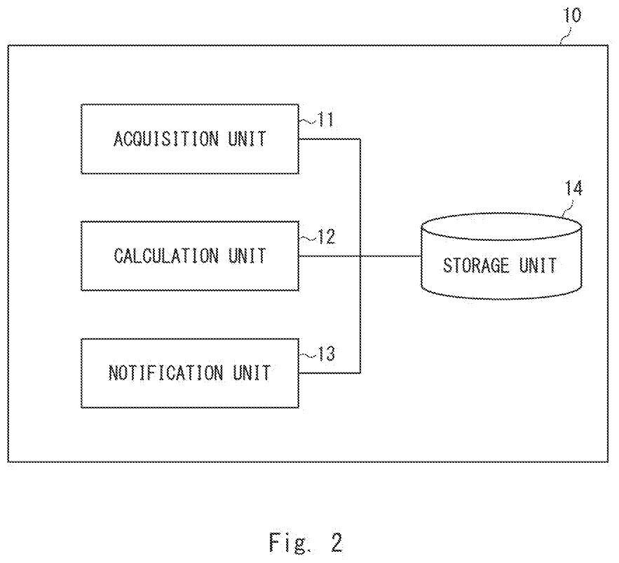

An information processing apparatus 10 according to the second example embodiment is described with reference to FIG. 2. FIG. 2 is a diagram showing a configuration example of the information processing apparatus according to the second example embodiment. For example, the information processing apparatus 10 may be a communication terminal such as a smartphone or a tablet terminal, or may be a personal computer apparatus, a server apparatus, or the like. The information processing apparatus 10 includes an acquisition unit 11, a calculation unit 12, a notification unit 13, and a storage unit 14.

The acquisition unit 11 acquires the position of a user. For example, when the information processing apparatus 10 is a communication terminal, the acquisition unit 11 may include a Global Positioning System (GPS) receiver and acquire the position of a user using the GPS receiver. Alternatively, the acquisition unit 11 may function as an input unit and may receive the position input by a user and use the received position as a position of the user.

For example, when the information processing apparatus 10 is a personal computer apparatus, a server apparatus, or the like, the acquisition unit 11 may acquire a position which a user has input to a communication terminal owned by the user from the communication terminal, and use the acquired position as a position of the user.

The acquisition unit 11 acquires reservation information of the aircraft which a user plans to board. The reservation information includes the boarding flight number, the scheduled boarding time, and the scheduled boarding place of the aircraft which a user plans to board. For example, when the information processing apparatus 10 is a communication terminal, the acquisition unit 11 may function as an input unit and acquire reservation information input by a user by receiving it. Alternatively, the acquisition unit 11 may store reservation information registered in advance by a user and acquire the stored reservation information. Alternatively, the acquisition unit 11 may acquire reservation information from a server apparatus or the like that manages information about a user.

For example, when the information processing apparatus 10 is a personal computer apparatus, a server apparatus, or the like, the acquisition unit 11 may acquire reservation information which a user has input to a communication terminal owned by the user from the communication terminal. Alternatively, the acquisition unit 11 may store in advance reservation information of the aircraft which a user has reserved through the communication terminal and acquire the stored reservation information. Alternatively, the acquisition unit 11 may acquire reservation information from a server apparatus or the like that manages information about a user.

The acquisition unit 11 acquires a boarding flight number by a user inputting the boarding flight number of the aircraft which a user plans to board. The acquisition unit 11 may acquire a scheduled boarding time associated with the boarding flight number and a scheduled boarding place from a server apparatus managed by the airline company that operates the aircraft which a user plans to board. Alternatively, the acquisition unit 11 may receive a scheduled boarding time associated with the boarding flight number and a scheduled boarding place from a server apparatus managed by the airport including the scheduled boarding place. The scheduled boarding place may be a predetermined position in the boarding area of the airport including the scheduled boarding place or may be a boarding gate of the aircraft which a user plans to board.

The calculation unit 12 calculates, based on the reservation information acquired by the acquisition unit 11, a travel time including a spare time corresponding to the travel route and the mode of transportation from the position of a user acquired by the acquisition unit 11 to the scheduled boarding place of the aircraft which the user plans to board.

The travel time includes a required travel time and a spare time. The required travel time includes a travel time required to travel from the position acquired by the acquisition unit 11 to the scheduled boarding place, and a procedure time required for procedures required from the arrival place at the airport to the scheduled boarding place.

The spare time is a spare time for the scheduled boarding time of the aircraft which a user plans to board, and a time between an arrival time in a case where a user arrives at the scheduled boarding place without delay when the user uses the travel route and the mode of transportation selected by himself/herself, and a scheduled boarding time of the aircraft which the user plans to board. Further, the spare time is a time in which a delay time due to a delay that may occur is taken into consideration, and is a time in which it is predicted that a user will be able to arrive on time for the scheduled boarding time even if a delay has occurred.

The calculation unit 12 acquires (i.e., retrieves) a travel route and a mode of transportation that can be used to travel from the position acquired by the acquisition unit 11 to the scheduled boarding place. For example, the calculation unit 12 may acquire, from a server apparatus that provides route search information, a travel route and a mode of transportation that can be used to travel from the position acquired by the acquisition unit 11 to the scheduled boarding place. Note that the acquisition unit 11 may acquire (i.e., retrieve) a travel route and a mode of transportation.

The calculation unit 12 calculates a required travel time based on the acquired travel route and mode of transportation. The calculation unit 12 may calculate the required travel time based on the distance determined based on the acquired travel route and the speed of the mode of transportation determined based on the acquired mode of transportation. For example, when the acquired mode of transportation is an automobile, the calculation unit 12 may calculate the required travel time based on the distance determined based on the travel route and the average speed of the automobile. Alternatively, the calculation unit 12 may calculate the required travel time based on the time schedule of the acquired mode of transportation. For example, when the acquired mode of transportation is a train or a bus, the calculation unit 12 may calculate the required travel time based on the timetable of the train or the bus. Alternatively, the calculation unit 12 may calculate the required travel time based on past history information.

The procedure time may be a time required for the procedures in an inspection area of the airport including the scheduled boarding place. The inspection area is an area in which the security checkpoint and the passport control area at the aforementioned airport are combined and is an area which extends from the entrance of the security checkpoint to the exit of the passport control area. Note that the inspection area may be only the area of the security checkpoint or may be the area which extends from the entrance of the security checkpoint to the exit thereof.

The calculation unit 12 may set the average time required for the procedures in the inspection area as a procedure time or may use the maximum time required for the procedures in the inspection area as a procedure time. Alternatively, the calculation unit 12 may calculate a procedure time based on, for example, the security checkpoint congestion degree information provided by the airport including the scheduled boarding place.

The calculation unit 12 calculates a spare time corresponding to the travel route and the mode of transportation. This example embodiment introduces a safety coefficient and two degrees of reliability (a degree 1 of reliability and a degree 2 of reliability) in order to calculate a spare time. The calculation unit 12 calculates a spare time using the safety coefficient, the degree 1 of reliability (a first degree of reliability) and the degree 2 of reliability (a second degree of reliability).

The safety coefficient is a coefficient corresponding to the mode of transportation and the travel route that are used to calculate the spare time. The safety coefficient is a coefficient for determining a prediction error of the travel time when a delay in the combination of the mode of transportation and the travel route occurs. The degree 1 of reliability (the first degree of reliability) is a degree of reliability based on a potential risk indicating a possibility that a delay may occur. The degree 2 of reliability (the second degree of reliability) is a degree of reliability based on the degree of influence that a delay has when the delay occurs.

The calculation unit 12 calculates the degree 1 of reliability and the degree 2 of reliability based on detour route information about detour routes for each combination of the mode of transportation and the travel route and delay information about a delay that has occurred in the past for each combination of the mode of transportation and the travel route. The calculation unit 12 calculates a safety coefficient using the degree 1 of reliability and the degree 2 of reliability. The calculation unit 12 calculates a spare time corresponding to the travel route and the mode of transportation based on the safety coefficient corresponding to the travel route and the mode of transportation.

When the calculation unit 12 has acquired the mode of transportation and the travel route, it acquires detour route information about detour routes for each combination of the mode of transportation and the travel route, and delay information about a delay that has occurred in the past for each combination of the mode of transportation and the travel route. The calculation unit 12 sets the acquired information in a travel route information table T1. The storage unit 14, which will be described later, stores the travel route information table T1. Note that the acquisition unit 11 may acquire detour route information and delay information.

When the calculation unit 12 has calculated a degree 1 of reliability, a degree 2 of reliability, a safety coefficient, a spare time, a travel time to be required, and a travel time, the calculation unit 12 sets the calculated various information items in a travel time table T2. The storage unit 14, which will be described later, stores the travel time table T2.

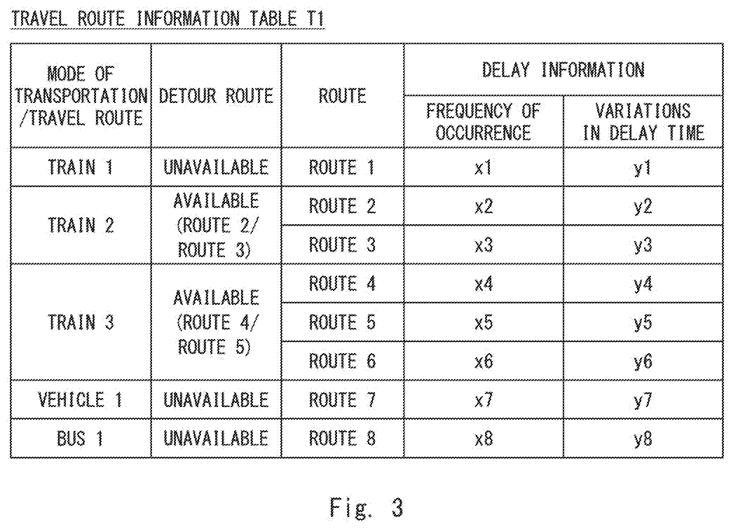

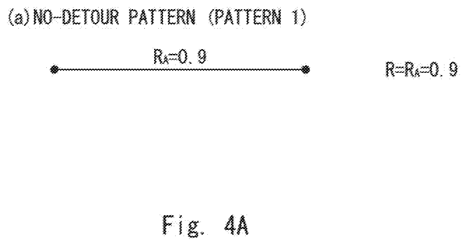

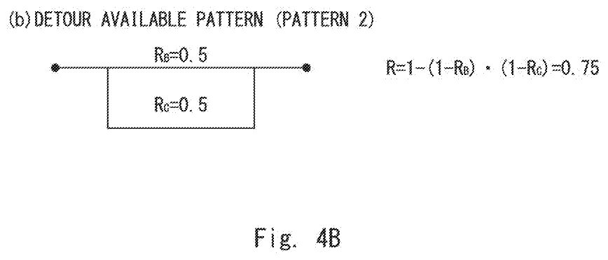

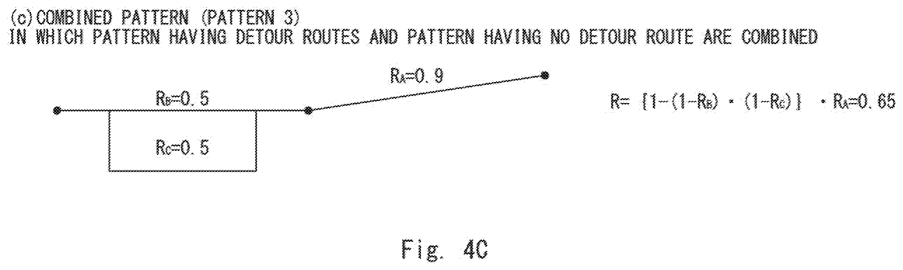

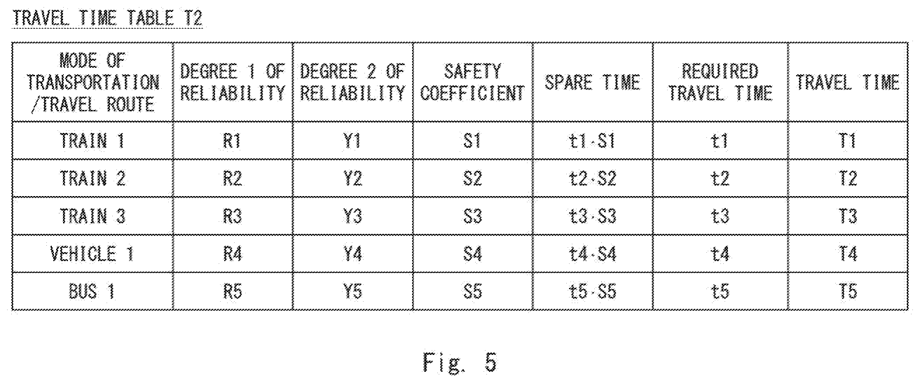

Examples of the travel route information table T1 and the travel time table T2, and calculation processing in which the calculation unit 12 calculates a spare time using the travel route information are described below with reference to FIGS. 3 to 5. FIG. 3 is a diagram showing an example of a travel route information table. FIGS. 4A to 4C are diagrams showing calculation processing for calculating a spare time. FIG. 5 is a diagram showing an example of a travel time table.

An example of the travel route information table T1 is described with reference to FIG. 3. The travel route information table T1 is a table in which information about detour routes for each combination of the acquired mode of transportation and travel route, and the acquired delay information are set. In the travel route information table T1, a mode of transportation/travel route, a detour route, a route, and delay information are set in order from the left side thereof.

In the mode of transportation/travel route, a mode of transportation and a travel route that can be used to travel from the position acquired by the acquisition unit 11 to the scheduled boarding place where a user plans to board are set. In the mode of transportation/travel route, a combination of the mode of transportation acquired by the calculation unit 12 and the number of the travel route acquired by the calculation unit 12 is set.

It is assumed that the calculation unit 12 has acquired, for example, a train, a vehicle, and a bus as modes of transportation that can be used to travel from the acquired position to the scheduled boarding place. Further, it is assumed that the calculation unit 12 has acquired, for example, three travel routes as travel routes for a train. In this case, a “train 1”, a “train 2”, and a “train 3”, each of which represents a combination of the mode of transportation and the number of the travel route, are set in the mode of transportation/travel route. For example, when there is only one travel route for a vehicle and a bus and the calculation unit 12 acquires one travel route, a “vehicle 1” and a “bus 1”, each of which represents a combination of the mode of transportation and the number of the travel route, are set in the mode of transportation/travel route.

Detour rout information is set in the detour route. Specifically, in the detour route, a presence or absence of the detour route indicating whether there is a detour route in the travel route from the position of a user acquired by the acquisition unit 11 to the scheduled boarding place where the user plans to board is set. Further, in the detour route, when there is a detour route, information about a route constituting the detour route, which indicates which route is the detour route, is set.

For example, it is assumed that there is a detour route for each of the “train 2” and the “train 3” in the travel route from the position acquired by the acquisition unit 11 to the scheduled boarding place. In this case, as shown in FIG. 3, “available” is set in the detour route of each of the “train 2” and the “train 3”. When the routes constituting the detour route among routes 4 to 6 included in the travel route of the “train 3” are the routes 4 and 5, a “route 4/route 5” is set as shown in FIG. 3. That is, the route 4 and the route 5 constitute detour routes, and there is no detour route in the route 6.

Routes included in the travel route are set for the route. Information set on the route may be referred to as a section of the travel route.

In the delay information, for each travel route set in the mode of transportation/travel route, delay information about a delay that has occurred in the past is set. The delay information includes a frequency of occurrence and variations in delay time.

In the frequency of occurrence, a frequency of occurrence of the delay that has occurred in the past in each route is set, and the number of delays that have occurred per unit period (unit time) is set. In the frequency of occurrence, for example, the number of occurrences of delays that have occurred in one year is set. For example, the calculation unit 12 acquires information from a management server managed by a company that operates a train, a bus, or the like, and a management server from which traffic congestion situation is collected, and set the acquired information in the frequency of occurrence.

Note that in the frequency of occurrence, a frequency of occurrence of delay for each predetermined time may be set, a frequency of occurrence of delay for each day of the week may be set, or a frequency of occurrence of delay for each season may be set. When the information set in the frequency of occurrence is a frequency of occurrence of delay for each predetermined time, it is possible to reflect the delay situation during a crowded commuting time. When the information set in the frequency of occurrence is a frequency of occurrence of delay for each day of the week, for example, it is possible to reflect the characteristics of the occurrence of the delay for each day of the week such as the fact that delays often occur on Friday. When the information set in the frequency of occurrence is a frequency of occurrence of delay for each season, for example, it is possible to reflect the characteristics of occurrence of the delay for each season such as the fact that delays often occur during a crowded long vacation period. Further, the frequency of occurrence may be determined by combining the frequencies of occurrences of delays for the different units described above, and the determined frequency of occurrence may be set in the frequency of occurrence of the travel route information table T1.

In the variations in delay time, an index value indicating the variations in delay time of the delay that has occurred in the past is set. A dispersion of delay time is set in the variations in delay time. Note that the variations in delay time may be a standard deviation of delay time or a variation coefficient. For example, the calculation unit 12 acquires information from the management server managed by the company that operates a train, a bus, or the like, and a management server from which traffic congestion situation is collected, and set the acquired information in the variations in delay time.

Next, the calculation processing for the degree 1 of reliability is described with reference to FIG. 3 and FIGS. 4A to 4C. As described above, the degree 1 of reliability is a degree of reliability based on a potential risk indicating a possibility that a delay may occur. The degree 1 of reliability is calculated based on the frequency of occurrence included in the detour route information and the delay information set in the travel route information table T1.

The calculation unit 12 calculates the degree 1 of reliability for each route in the travel route information table T1 by using the frequency of occurrence in the travel route information table T1. The calculation unit 12 calculates a rate of occurrence of delay for each route in the travel route information table T1, and calculates a value obtained by subtracting the calculated rate of occurrence of delay from 1 as the degree 1 of reliability of each of the routes.

Specifically, the calculation unit 12 calculates a rate of occurrence of delay for each route in the travel route information table T1 by using the frequency of occurrence in the travel route information table T1 and the number of times the routes in the travel route information table T1 have been selected in the past.

For example, it is assumed that a delay of 10 times has occurred in one year in a route 1 and that the number of times the route 1 is selected is 100 times in one year. In this case, the rate of occurrence of delay of the route 1 is calculated by dividing the number of times of occurrence of delay by the number of times of selection, and 10/100=0.1 is obtained. Further, the degree 1 of reliability of the route 1 is 1-0.1=0.9. The degree 1 of reliability for each of the routes 2 to 8 can also be calculated by performing a calculation similar to that performed for the route 1.

The calculation unit 12 calculates the degree 1 of reliability for each combination of the mode of transportation and the travel route based on the degree 1 of reliability for each route calculated as described above and the detour route information in the travel route information table T1.

It should be noted that when the travel routes are classified using the detour route information, they can be classified into a no-detour pattern (a pattern 1) having no detour route, a detour available pattern (a pattern 2) having detour routes, and a combined pattern (a pattern 3) in which a pattern having some detour routes and a pattern having no detour route are combined. When this classification is applied to the mode of transportation/travel route in FIG. 3, the “train 1”, the “vehicle 1”, and the “bus 1” are each classified as the pattern 1. The “train 2” is classified as the pattern 2. The “train 3” is classified as the pattern 3.

A method for obtaining the degree 1 of reliability for each combination of the mode of transportation and the travel route for the patterns 1 to 3 is described with reference to FIGS. 4A to 4C. FIG. 4A shows a method for obtaining the degree 1 of reliability for each combination of the mode of transportation and the travel route for the pattern 1. For example, it is assumed that a route A is included as a travel route, and the degree 1 of reliability of the route A is R_{A=0.9}. In this case, there is no detour route, and accordingly the degree 1 of reliability (R_{A}) of the route A is a degree 1 of reliability (R) for each combination of the mode of transportation and the travel route for the pattern 1, and R=0.9 is obtained.

With reference to the contents of the travel route information table T1 shown for example in FIG. 3, the “train 1” is a travel route of the pattern 1 since there is no detour route. It is assumed that the “train 1” includes the route 1 as a travel route, and the degree 1 of reliability of the route 1 is RT1. In this case, the degree 1 of reliability (R1) of the mode of transportation/travel route of the “train 1” is R1=RT1.

FIG. 4B shows a method for obtaining the degree 1 of reliability for each combination of the mode of transportation and the travel route for the pattern 2. For example, it is assumed that routes B and C are included as travel routes, the degree 1 of reliability of the route B is R_{B=0.5}, and the degree 1 of reliability of the route C is R_{C}=0.5. In this case, as shown in FIG. 4B, the degree 1 of reliability (R1) for each combination of the mode of transportation and the travel route is R1=1-(1-R_{B})·(1-R_{C})=0.75.

With reference to the contents of the travel route information table T1 shown for example in FIG. 3, the “train 2” is a travel route of the pattern 2 since there are detour routes. It is assumed that the “train 2” includes the routes 2 and 3 as travel routes, the degree 1 of reliability of the route 2 is RT2, and the degree 1 of reliability of the route 3 is RT3. In this case, the degree 1 of reliability (R2) of the mode of transportation/travel route of the “train 2” is calculated by R2=1-(1-RT2)·(1-RT3).

FIG. 4C shows a method for obtaining the degree 1 of reliability for each combination of the mode of transportation and the travel route for the pattern 3. It is assumed that the routes A to C are included as travel routes, the degree 1 of reliability of the route A is R_{A=0.9}, and the degree 1 of reliability of the route B is R_{B}=0.5, the degree 1 of reliability of the route C is R_{C}=0.5. In this case, as shown in FIG. 4C, the degree 1 of reliability (R) for each combination of the mode of transportation and the travel route is R={1-(1-R_{B})·(1-R_{C})}·R_{A}=0.65.

With reference to the contents of the travel route information table T1 shown for example in FIG. 3, the “train 3” is a travel route of the pattern 3 since there are some detour routes. The travel route information table T1 is set such that the route of the “train 3” includes the routes 4 to 6 and the routes constituting the detour route are the route 4 and the route 5. Accordingly, the calculation unit 12 can recognize that the route 4 and the route 5 of the “train 3” are detour routes, the route 6 is a route having no detour, and the “train 3” corresponds to the pattern 3. It is assumed that the “train 3” includes the routes 4 to 6 as travel routes, the degree 1 of reliability of the route 4 is RT4, the degree 1 of reliability of the route 5 is RTS, and the degree 1 of reliability of the route 6 is RT6. In this case, the degree 1 of reliability (R3) of the mode of transportation/travel route of the “train 3” is calculated by R3={1-(1-RT4)·(1-RT5)}·RT6.

Next, the degree 2 of reliability is described with reference to FIG. 3 and FIGS. 4A to 4C. As described above, the degree 2 of reliability is a degree of reliability based on the degree of influence that a delay has when the delay occurs. The degree 2 of reliability is calculated based on the detour routes (the detour route information) set in the travel route information table T1 and the variations in delay time included in the delay information.

The calculation unit 12 calculates the degree 2 of reliability for each route in the travel route information table T1 by using the variations in delay time in the travel route information table T1. The calculation unit 12 calculates the reciprocals of the variations in delay time in the moving route information table T1 as the reliability 2 for each route.

The calculation unit 12 calculates the degree 2 of reliability for each combination of the mode of transportation and the travel route based on the degree 2 of reliability for each route calculated as described above and the detour route information in the travel route information table T1. When the calculation unit 12 has calculated the degree 2 of reliability for each route, as in the case of the degree 1 of reliability, the calculation unit 12 determines which pattern shown in FIGS. 4A to 4C corresponds to the combination of the mode of transportation and the travel route based on the detour route information. Then, the calculation unit 12 calculates, using the degree 2 of reliability for each route, the degree 2 of reliability for each combination of the mode of transportation and the travel route in the same manner as the method for obtaining the degree 1 of reliability shown in FIGS. 4A to 4C.

With reference to the contents of the travel route information table T1 shown for example in FIG. 3, the “train 1” is a travel route of the pattern 1. It is assumed that the “train 1” includes the route 1 as a travel route, and the index value indicating the variations in delay time of the route 1 is yl1 In this case, the degree 2 of reliability (Y1) of the mode of transportation/travel route of the “train 1” is Y1=1/y1. The calculation unit 12 calculates, for the “train 2”, the “train 3”, the “vehicle 1”, and the “bus 1” in the travel route information table T1, the degree 2 of reliability for each combination of the mode of transportation and the travel route in the same manner as the method for obtaining the degree 1 of reliability shown in FIGS. 4A to 4C.

Next, a safety coefficient S is described. The safety coefficient S is calculated based on the degree 1 of reliability (R) and the degree 2 of reliability (Y). That is, the safety coefficient S is determined based on detour route information for each combination of the mode of transportation and the travel route, and delay information for each combination of the mode of transportation and the travel route. The safety coefficient S is calculated by subtracting the product of the degree 1 of reliability and the degree 2 of reliability from 1. When the safety coefficient S is expressed by an expression, it can be expressed as the following Expression (1), and the calculation unit 12 calculates the safety coefficient S using the following Expression (1).

S=1-Y·R (1)

Next, the travel time, the required travel time, and the spare time are described. Assuming that the travel time is T, the required travel time is t, and the safety coefficient is S, the spare time is calculated by multiplying the required travel time t by the safety coefficient S. That is, the spare time is calculated by t·S. Note that the required travel time used to calculate the spare time may include or exclude the procedure time required for the procedures in the inspection area in the airport facility.

The travel time, the required travel time, and the spare time can be expressed by the following Expression (2). The calculation unit 12 calculates the travel time including the spare time by using the following Expression (2).

T=t+t·S (2)

When the calculation unit 12 has calculated various information as described above, it sets the calculated information in the travel time table T2. An example of the travel time table T2 is described with reference to FIG. 5. In the travel time table T2, a mode of transportation/travel route, a degree 1 of reliability, a degree 2 of reliability, and a safety coefficient, a spare time, a required travel time, and a travel time are set from the left side thereof.

In the mode of transportation/travel route, the mode of transportation/travel route set in the travel route information table T1 is set.

In the degree 1 of reliability, the degree 1 of reliability calculated by the calculation unit 12 for each combination of the mode of transportation and the travel route is set.

In the degree 2 of reliability, the degree 2 of reliability calculated by the calculation unit 12 for each combination of the mode of transportation and the travel route is set.

In the safety coefficient, a safety coefficient for each combination of the mode of transportation and the travel route calculated by the calculation unit 12 using the degree 1 of reliability, the degree 2 of reliability, and Expression (1) is set.

In the spare time, a spare time for each combination of the mode of transportation and the travel route calculated by the calculation unit 12 is set.

In the required travel time, the required travel time, which is a time required to travel from the position of a user to the scheduled boarding place and is calculated by the calculation unit 12, is set. The required travel time may include a travel time required to travel from the position acquired by the acquisition unit 11 to the scheduled boarding place included in the reservation information, and a procedure time required for the procedures required from the arrival place at the airport to the scheduled boarding place.

In the travel time, a travel time required to travel from the position of a user to the scheduled boarding place is set. In the travel time, a time including the required travel time and the spare time is set, and the travel time calculated by the calculation unit 12 using Expression (2) is set.

Returning to FIG. 2, the notification unit 13 is described. The notification unit 13 notifies a user of the travel time corresponding to the travel route and the mode of transportation, which has been calculated by the calculation unit 12. For example, when the information processing apparatus 10 is a communication terminal, the notification unit 13 includes a display unit such as a display, and may display the travel time corresponding to the mode of transportation on the display unit to notify a user of the travel time. For example, when the information processing apparatus 10 is a personal computer apparatus, a server apparatus, or the like, the notification unit 13 may notify the communication terminal owned by a user of the travel time corresponding to the mode of transportation, and display the travel time on the display unit included in the communication terminal of the user. The storage unit 14 stores the travel route information table T1 and the travel time table T2.

<Operation Example of Information Processing Apparatus>

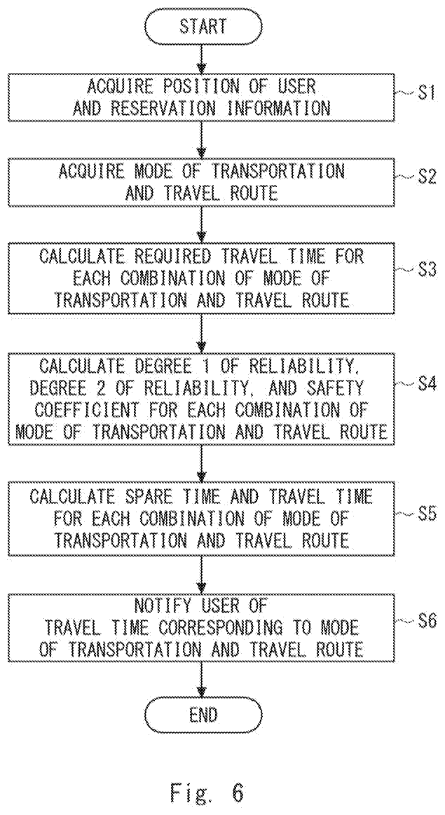

An operation example of the information processing apparatus 10 according to the second example embodiment is described with reference to FIG. 6. FIG. 6 is a diagram showing an operation example of the information processing apparatus according to the second example embodiment.

First, the acquisition unit 11 acquires the position of a user and the reservation information of the aircraft which the user plans to board (Step S1). The calculation unit 12 acquires modes of transportation and travel routes that can be used to travel from the position of the user to the scheduled boarding place (Step S2).

The calculation unit 12 calculates a required travel time for each combination of the mode of transportation and the travel route (Step S3). The calculation unit 12 calculates a degree 1 of reliability, a degree 2 of reliability, and a safety coefficient for each combination of the mode of transportation and the travel route (Step S4).

The calculation unit 12 calculates the degree 1 of reliability for each route in the travel route information table T1 by using the frequency of occurrence in the travel route information table T1. The calculation unit 12 calculates a rate of occurrence of delay for each route in the travel route information table T1, and calculates a value obtained by subtracting the calculated rate of occurrence of delay from 1 as the degree 1 of reliability of each route. The calculation unit 12 calculates the degree 1 of reliability for each combination of the mode of transportation and the travel route based on the degree 1 of reliability for each route and the detour route information in the travel route information table T1.

The calculation unit 12 calculates the degree 2 of reliability for each route in the travel route information table T1 by using the variations in delay time in the travel route information table T1. The calculation unit 12 calculates the reciprocals of the variations in delay time in the moving route information table T1 as the reliability 2 for each route. The calculation unit 12 calculates the degree 2 of reliability for each combination of the mode of transportation and the travel route based on the calculated degree 2 of reliability for each route and the detour route information in the travel route information table T1.

The calculation unit 12 calculates a safety coefficient for each combination of the mode of transportation and the travel route using the degree 1 of reliability and the degree 2 of reliability calculated for each combination of the mode of transportation and the travel route, and Expression (1). Note that the order of Steps S3 and S4 may be the order shown in FIG. 6, or Step S4 may be performed and then Step S3 may be performed.

The calculation unit 12 calculates a spare time and a travel time for each combination of the mode of transportation and the travel route (Step S5). The calculation unit 12 multiplies the required travel time calculated in Step S3 by the safety coefficient calculated in Step 4 to calculate a spare time for each combination of the mode of transportation and the travel route. The calculation unit 12 calculates a travel time corresponding to the mode of transportation and the travel route by adding the spare time and the required travel time for each combination of the mode of transportation and the travel route.

The notification unit 13 notifies a user of the travel time corresponding to the mode of transportation and the travel route, which has been calculated in Step S5 (Step S6).

As described above, the acquisition unit 11 acquires the position of a user and the reservation information of the aircraft which the user plans to board, and the calculation unit 12 calculates a travel time in which the spare time corresponding to the travel route and the mode of transportation which the user can use is taken into consideration. The notification unit 13 notifies a user of the travel time including the spare time. Accordingly, by using the information processing apparatus 10 according to the second example embodiment, it is possible for a user to arrive at the airport with time to spare no matter which mode of transportation the user uses, and to take flexible actions in accordance with the congestion situation in the airport facility. Therefore, the information processing apparatus 10 according to the second example embodiment makes it possible to contribute to relief from the congestion in the airport facility.

Further, the calculation unit 12 calculates a spare time by calculating a degree 1 of reliability, a degree 2 of reliability, and a safety coefficient for each combination of the mode of transportation and the travel route to travel from the position of a user to the scheduled boarding place. The calculation unit 12 calculates a degree 1 of reliability and a degree 2 of reliability for the combination of the mode of transportation and the travel route based on the information about the delays that have occurred in the past. Accordingly, the calculation unit 12 can calculate a spare time in which delays assumed from the past delay information are taken into consideration. Thus, it is possible for a user to be prevented from unexpectedly coming to the airport early and unexpectedly coming to the airport late by travelling to the airport based on the travel time notified from the information processing apparatus 10. That is, the information processing apparatus 10 according to the second example embodiment makes it possible to propose (notify) an appropriate travel time to a user, thereby enabling a further improvement of the user convenience.

It is generally conceivable here that the distribution (characteristics) of delay time will differ as the mode of transportation differs. For example, when the mode of transportation is a vehicle, the delay time greatly changes due to a traffic congestion, and thus it is conceivable that the dispersion of the distribution of the delay time will be large. On the other hand, when the mode of transportation is a train, it is conceivable that the dispersion of the distribution of the delay time will be small since the train operates according to the timetable. As described above, the calculation unit 12 calculates a spare time for each combination of the mode of transportation and the travel route using the past delay information, and the calculated spare time is a spare time in which the distribution of the delay time corresponding to the mode of transportation is taken into consideration. Thus, the information processing apparatus 10 according to the second example embodiment makes it possible to calculate an appropriate travel time corresponding to the mode of transportation.

### Modified Example

In the second example embodiment described above, the following modifications may be made.

<1> The delay information included in the travel route information table T1 may further include a delay time. In this case, the calculation unit 12 determines a weight coefficient based on the delay time. When the degree 1 of reliability is calculated for each route, the calculation unit 12 performs weighting with a weight coefficient based on the delay time and calculates the degree 1 of reliability for each route weighted based on the delay time. The calculation unit 12 calculates a safety coefficient for each combination of the mode of transportation and the travel route based on the degree 1 of reliability for each of the weighted routes and the detour route information, and calculates a spare time using the calculated safety coefficient.

By this configuration, it is possible to have the same effect as in the above-described second example embodiment and to calculate a more appropriate degree 1 of reliability. Specifically, it is possible to obtain a degree 1 of reliability in which a risk due to the delay time when the delay has occurred is taken into consideration, such as when a delay time is large when the delay has occurred although the frequency of occurrence of delay is low and when a delay time is small when the delay has occurred although the frequency of occurrence of delay is high.

<2> The acquisition unit 11 acquires information about predicted delays predicted to occur by the scheduled boarding time for each combination of the mode of transportation and the travel route, and the calculation unit 12 may correct the calculated travel time based on the acquired information about predicted delays.

For example, the information about predicted delays includes a predicted delay time for each combination of the mode of transportation and the travel route, and the calculation unit 12 determines a weight coefficient based on the predicted delay time. The calculation unit 12 may perform weighting to the safety coefficient in accordance with the determined weight coefficient. Alternatively, the calculation unit 12 may perform weighting to the travel time in accordance with the determined weight coefficient. By this configuration, it is possible to have the same effect as in the above-described second example embodiment and to calculate a more appropriate travel time.

<3> The calculation unit 12 monitors an increase or a decrease of the spare time included in the travel time, and may correct the calculated spare time based on the increase or the decrease of the calculated spare time. Specifically, when the calculated spare time is increasing, the calculation unit 12 may perform a correction so that the spare time is not increased from the previous calculated time. Alternatively, when the calculated spare time is decreasing, the calculation unit 12 may perform a correction so that the spare time is not decreased from the previous calculated time. By this configuration, it is possible to have the same effect as in the above-described second example embodiment.

<4> The acquisition unit 11 may acquire the position of a user and the mode of transportation and the travel route actually used by the user as required. Then, the calculation unit 12 corrects the travel time including the spare time every time the acquisition unit 11 acquires the position of the user, the notification unit 13 may notify the user of the corrected travel time as required.

### Third Example Embodiment

Next, a third example embodiment is described. The third example embodiment is a modified example of the second example embodiment.

<Configuration Example of Information Processing Apparatus>

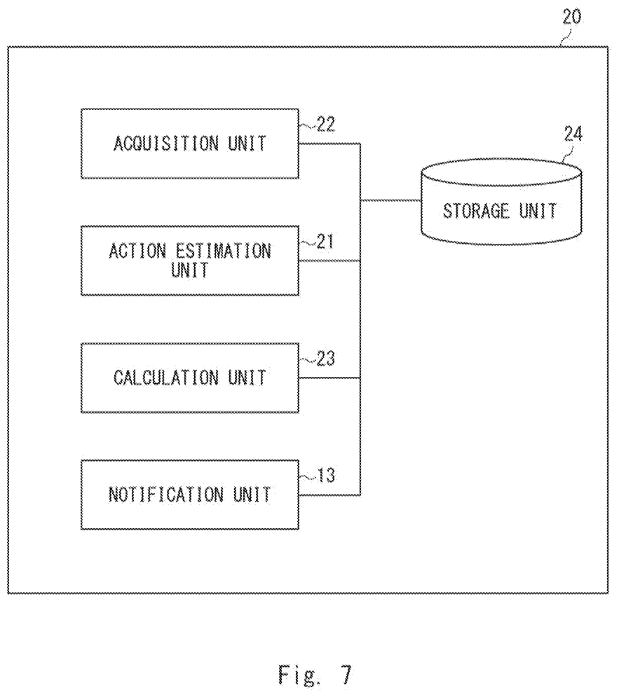

An information processing apparatus 20 according to the third example embodiment is described with reference to FIG. 7. FIG. 7 is a diagram showing a configuration example of the information processing apparatus according to the third example embodiment.

The configuration of the information processing apparatus 20 according to the third example embodiment is the same as that of the information processing apparatus 10 according to the second example embodiment except for the addition of an action estimation unit 21. Further, the configuration of the information processing apparatus 20 according to the third example embodiment is the same as that of the information processing apparatus 10 according to the second example embodiment except that the acquisition unit 11 is replaced with an acquisition unit 22, the calculation unit 12 is replaced with a calculation unit 23, and the storage unit 14 is replaced with a storage unit 24. Note that the acquisition unit 11 and the notification unit 13 are similar to those in the second example embodiment, and the description thereof will be omitted as appropriate.

The configuration of the acquisition unit 22 is the same as that of the acquisition unit 11 of the second example embodiment, and further has the following configuration. The acquisition unit 22 specifies the mode of transportation that a user has used when the user has traveled to the airport in the past. For example, when the acquisition unit 22 starts to acquire the position of a user, the acquisition unit 22 periodically acquires the position of the user and specifies the mode of transportation from the transition of the position of the user. The acquisition unit 22 sets the specified mode of transportation in an action history table T3 which will be described later.

For example, when the acquisition unit 22 determines from the position of a user that the user has been at the station or when the acquisition unit 22 determines that the user has traveled on the track, the acquisition unit 22 may specify the mode of transportation as a train. For example, when the acquisition unit 22 determines from the position of a user that the user has traveled on the road, the acquisition unit 22 may specify the mode of transportation as a vehicle or a bus. As the acquisition unit 22 can calculate a travel speed from the successive positions of a user, the acquisition unit 22 may specify the mode of transportation based on the travel speed.

The acquisition unit 22 acquires the actual travel time when a user has traveled to the airport in the past. For example, when the acquisition unit 22 starts to acquire the position of a user, it starts a measurement of a travel time, and ends the measurement when the user arrives at the scheduled boarding place at the airport and then acquires the actual time. The acquisition unit 22 sets the actual travel time in the action history table T3.

The acquisition unit 22 acquires the time of the delay that has occurred when a user has traveled to the airport in the past. For example, the calculation unit 22 acquires a delay time from the management server managed by the company that operates a train, a bus, or the like, and the management server from which traffic congestion situation is collected. The acquisition unit 22 sets the acquired delay time in the action history table T3.

The acquisition unit 22 acquires the length of stay which a user who has traveled to the airport in the past has stayed at a place that is not included in the travel route, such as a tourist site, a tourist spot, or a commercial facility. For example, when the acquisition unit 22 starts to acquire the position of a user, the acquisition unit 22 periodically acquires the position of the user. When a user travels to a place that is not included in the travel route acquired by the calculation unit 23, the acquisition unit 22 measures and acquires the length of stay in the place. The acquisition unit 22 sets the acquired length of stay in the action history table T3.

The storage unit 24 further includes the action history table T3 in addition to the travel route information table T1 and the travel time table T2.

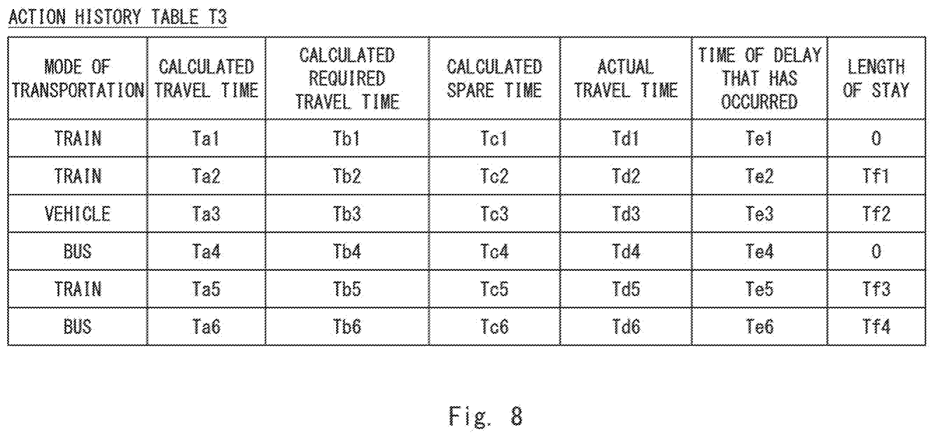

An example of the action history table T3 is described with reference to FIG. 8. FIG. 8 is a diagram showing an example of the action history table. The action history table T3 is a table in which the action history of a user is managed and is a table in which history information when the user has traveled to the airport in the past is managed. In the action history table T3, a mode of transportation, a calculated travel time, a calculated required travel time, a calculated spare time, an actual travel time, a time of the delay that has occurred, and a length of stay are set in order from the left side thereof.

In the mode of transportation, the mode of transportation that a user has used when the user has traveled to the airport in the past is set, and the mode of transportation specified by the acquisition unit 22 is set.

In the calculated travel time, the travel time calculated by the calculation unit 23 when a user has traveled to the airport in the past is set.

In the calculated required travel time, the required travel time calculated by the calculation unit 23 when a user has traveled to the airport in the past is set.

In the calculated spare time, the spare time calculated by the calculation unit 23 when a user has traveled to the airport in the past is set.

In the actual travel time, the actual travel time when a user has traveled to the airport in the past is set, and the actual travel time acquired by the acquisition unit 22 is set.

In the time of the delay that has occurred, the time of the delay that has occurred when a user has traveled to the airport in the past is set, and the delay time acquired by the acquisition unit 22 is set.

In the length of stay, the length of stay which a user who has traveled to the airport in the past has stayed in a place not included in the travel route is set, and the length of stay acquired by the acquisition unit 22 is set.

Returning to FIG. 7, the action estimation unit 21 is described. The action estimation unit 21 estimates the action characteristic of a user based on the action history of the user managed in the action history table T3. The action estimation unit 21 determines (calculates) a correction time for correcting the spare time based on the estimated action characteristic.

The action estimation unit 21 estimates whether a user has the action characteristic in which the user stays at a place that is not included in the travel route based on the action history in the action history table T3. Note that the action estimation unit 21 may estimate, for each mode of transportation, whether a user has the action characteristic in which the user stays at a place that is not included in the travel route based on the action history in the action history table T3.

The action estimation unit 21 estimates whether a user has the action characteristic in which the user consumes a spare time due to a cause other than a delay, based on the action history in the action history table T3. Note that the action estimation unit 21 may estimate, for each mode of transportation, whether a user has the action characteristic in which the user consumes a spare time due to a cause other than a delay, based on the action history in the action history table T3.

Specifically, when the action history in which the length of stay in the action history table T3 is not 0 (zero) is included in a predetermined percentage or more of the entire action history, the action estimation unit 21 estimates that a user has the action characteristic in which the user stays at a place that is not included in the travel route.

The action estimation unit 21 calculates, for example, the average time of the length of stay included in the action history in which the length of stay is not 0 (zero), and determines the calculated average time as a correction time. The action estimation unit 21 transmits the determined correction time to the calculation unit 23. Note that the action estimation unit 21 may use the maximum length of stay as a correction time, or the minimum length of stay as a correction time.

When the action estimation unit 21 estimates, for each mode of transportation, whether a user has the action characteristic in which the user stays at a place that is not included in the travel route, the action estimation unit 21 may estimate that the user has the action characteristic in which the user stays at a place that is not included in the travel route by using the action history for each mode of transportation. In this case, when the action history, in which the length of stay time is not 0 (zero) among the action histories for each mode of transportation, is included in a predetermined percentage or more of the entire action history for each mode of transportation, the action estimation unit 21 may estimate that the user has the action characteristic in which the user stays at a place that is not included in the travel route by using the action history for each mode of transportation.

Further, the action estimation unit 21 specifies the action history in which a time obtained by subtracting, from the actual travel time in the action history table T3, the calculated required travel time and the time of the delay that has occurred is equal to or longer than a predetermined time. It can be suggested that the time obtained by subtracting, from the actual travel time, the calculated required travel time and the time of the delay that has occurred is a time (a consumption time) in which the spare time is consumed due to a cause other than a delay. When the action history in which the consumption time is equal to or longer than a predetermined time is included in a predetermined percentage or more of the entire action history, the action estimation unit 21 estimates that a user has the action characteristic in which the user consumes a spare time due to a cause other than a delay. Note that regarding the action history in which the length of stay is not 0 (zero), the action estimation unit 21 may calculate a consumption time by further subtracting the length of stay.

The action estimation unit 21 calculates the average time of the consumption time of the action history in which the consumption time is equal to or longer than a predetermined time and determines the calculated average time as a correction time. The action estimation unit 21 transmits the determined correction time to the calculation unit 23. Note that the action estimation unit 21 may use the maximum consumption time as a correction time, or the minimum consumption time as a correction time

When the action estimation unit 21 estimates, for each mode of transportation, whether a user has the action characteristic in which the user consumes a spare time due to a cause other than a delay, the action estimation unit 21 may estimate that the user has the action characteristic in which the user consumes a spare time due to a cause other than a delay by using the action history for each mode of transportation. In this case, when the action history, in which the consumption time is equal to or longer than a predetermined time among the action histories for each mode of transportation, is included in a predetermined percentage or more of the entire action history for each mode of transportation, the action estimation unit 21 may estimate that the user has the action characteristic in which the user consumes a spare time due to a cause other than a delay by using the action history for each mode of transportation.

The configuration of the calculation unit 23 is the same as that of the acquisition unit 12 of the second example embodiment and calculates a travel time including a spare time corresponding to the mode of transportation and the travel route as described in the second example embodiment. When the correction time is received from the action estimation unit 21, the calculation unit 23 adds the correction time to the calculated spare time, corrects the spare time, and calculates a travel time including the corrected spare time. When the action estimation unit 21 estimates that a user has the action characteristic in which the user stays at a place that is not included in the travel route and the action characteristic in which a user consumes a spare time due to a cause other than a delay, the calculation unit 23 sets the time obtained by adding the two received correction times as a correction time. <Operation Example of Information Processing Apparatus>

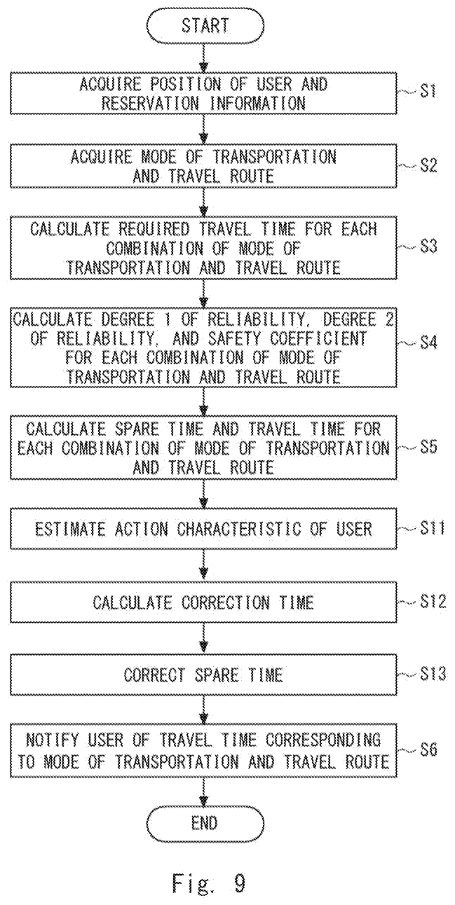

Next, the information processing apparatus 20 according to the third example embodiment is described with reference to FIG. 9. FIG. 9 is a diagram showing an operation example of the information processing apparatus according to the third example embodiment. The operation example shown in FIG. 9 is the same as that shown in FIG. 6 except for the addition of Steps S11 to S13. The operations performed in Steps S1 to S6 are similar to those performed in the second example embodiment, and the description thereof is thus omitted.

In Step S11, the action estimation unit 21 estimates the action characteristic of a user based on the action history table T3 (Step S11). The action estimation unit 21 estimates whether a user has the action characteristic in which the user stays at a place that is not included in the travel route based on the action history in the action history table T3. Further, the action estimation unit 21 estimates whether the user has the action characteristic in which the user consumes a spare time due to a cause other than a delay, based on the action history in the action history table T3.

The action estimation unit 21 calculates a correction time based on the estimated action characteristic (Step S12). When the action estimation unit 21 estimates that the user has the action characteristic in which the user stays at a place that is not included in the travel route, the action estimation unit 21 calculates a correction time based on the length of stay. Further, when the action estimation unit 21 estimates that the user has the action characteristic in which the user consumes a spare time due to a cause other than a delay, the action estimation unit 21 calculates a correction time based on the actual travel time, the calculated required travel time, and the time of the delay that has occurred. The action estimation unit 21 transmits the calculated correction time to the calculation unit 23.

The calculation unit 23 corrects the spare time calculated in Step S5 by using the correction time received in Step S12 (Step S13). The calculation unit 23 adds the correction time received in Step S12 to the spare time calculated in Step S5 and corrects the spare time. The calculation unit 23 calculates a travel time including the corrected spare time.

As described above, the information processing apparatus 20 according to the third example embodiment includes the action estimation unit 21, and the action estimation unit 21 estimates the action characteristic of a user based on the action history of the user. Specifically, the action estimation unit 21 calculates a correction time for correcting the spare time based on the estimated action characteristic. The calculation unit 23 corrects the calculated spare time based on the correction time and calculates a travel time including the corrected spare time.

As described above, the information processing apparatus 20 according to the third example embodiment calculates a spare time in which the action characteristic of a user is taken into consideration, and accordingly it is possible for the user to arrive at the airport with more time to spare than in the second example embodiment. Thus, a user can take flexible actions in accordance with the congestion situation in an airport facility, so that the information processing apparatus 20 according to the third example embodiment makes it possible to contribute to relief from the congestion in the airport facility.

### Modified Example

In the third example embodiment, the action estimation unit 21 may be modified so that it estimates a mode of transportation predicted to be selected by a user from the history information included in the action history table T3. In this case, the action estimation unit 21 may estimate the most selected mode of transportation from the modes of transportation in the action history table T3 as a mode of transportation predicted to be selected by a user. Alternatively, the action estimation unit 21 may analyze the trend of the mode of transportation selected by a user based on a predetermined number of history information pieces in order from the newest one among the history information pieces included in the action history table T3. The action estimation unit 21 may estimate a mode of transportation predicted to be selected by the user based on the result of the analysis.

The calculation unit 23 specifies an available travel route for the estimated mode of transportation. The calculation unit 23 calculates a travel time including the spare time corresponding to the estimated mode of transportation.

The notification unit 13 notifies a user of the mode of transportation estimated by the action estimation unit 21 and the travel time that is calculated by the calculation unit 23. The travel time includes the spare time corresponding to the mode of transportation.

By this configuration, a user can save time and effort in selecting a mode of transportation, and thus it is possible to improve the user convenience.

### Fourth Example Embodiment

Next, a fourth example embodiment is described. The fourth example embodiment is a modified example of the second and third example embodiments. In the following description, the fourth example embodiment will be explained with reference to the second example embodiment.

<Configuration Example of Information Processing Apparatus>

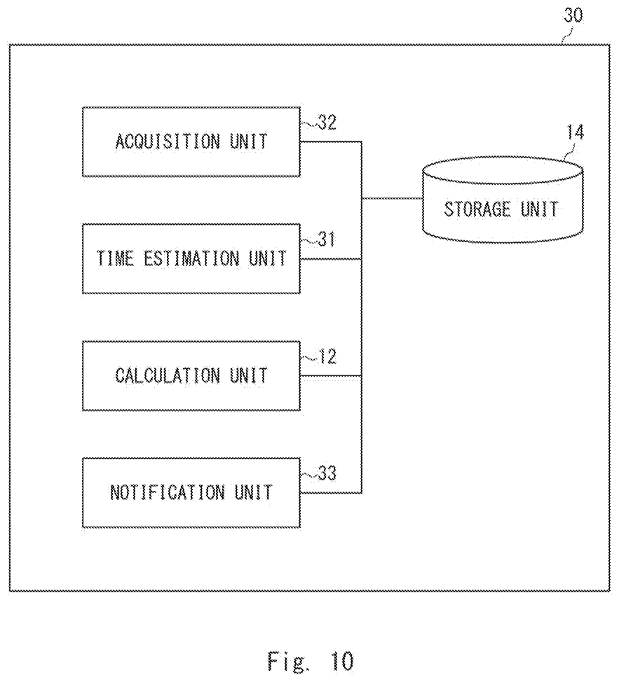

An information processing apparatus 30 according to the fourth example embodiment is described with reference to FIG. 10. FIG. 10 is a diagram showing a configuration example of the information processing apparatus according to the fourth example embodiment.

The configuration of the information processing apparatus 30 according to the fourth example embodiment is the same as that of the information processing apparatus 10 according to the second example embodiment except for the addition of a time estimation unit 31. Further, the configuration of the information processing apparatus 30 according to the fourth example embodiment is the same as that of the information processing apparatus 10 according to the second example embodiment except that the acquisition unit 11 is replaced with an acquisition unit 32 and the notification unit 13 is replaced with a notification unit 33. Note that the calculation unit 12 and the storage unit 14 are similar to those in the second example embodiment, and the description thereof will be omitted as appropriate.

The configuration of the acquisition unit 32 is the same as that of the acquisition unit 11 of the second example embodiment. Further, the acquisition unit 32 further acquires the arrival time at which a user arrives at the airport including the scheduled boarding place. The acquisition unit 32 may, for example, periodically acquire the position of a user, and acquire the time at which the position of the user is in the airport including the scheduled boarding place as an arrival time. Alternatively, the acquisition unit 32 may acquire, as an arrival time, either the time when a user has checked in the check-in terminal installed in the airport or the time when the user has checked his/her baggage, whichever is earlier. The acquisition unit 32 transmits the acquired arrival time to the calculation unit 33.

The time estimation unit 31 estimates a procedure time required for the procedures in the inspection area in the airport facility. The procedure time may be referred to as a pass-through time for passing through the inspection area. An image-pickup apparatus and a sensor are arranged in the inspection area of the airport, and the time estimation unit 31 acquires image data obtained by the image-pickup apparatus taking the image of the inspection area. Further, the time estimation unit 31 acquires sensing data acquired by the sensor.

The time estimation unit 31 calculates the number of waiting people waiting for the procedure at the procedure gate in the inspection area based on the image data. The time estimation unit 31 calculates a throughput indicating the number of people who pass through the procedure gate per unit time based on the sensing data. The throughput may be, for example, the number of people passing through the procedure gate per minute. The time estimation unit 31 estimates the procedure time required for the procedure in the inspection area using the number of waiting people and the throughput. The time estimation unit 31 transmits the estimated procedure time to the notification unit 33.

When there are a plurality of procedure gates in the inspection area, the time estimation unit 31 calculates the throughput of each procedure gate based on the sensing data. The time estimation unit 31 calculates an overall throughput in the inspection area from the sum of the throughputs of the procedure gates. The time estimation unit 31 estimates the procedure time using the overall throughput and the number of waiting people.

The configuration of the notification unit 33 is the same as that of the notification unit 13. Further, the notification unit 33 determines information to be notified to a user based on the procedure time received from the time estimation unit 31, the arrival time and the scheduled boarding time. The notification unit 33 notifies the user of the determined information. The notification unit 33 calculates an allowable time of staying at the airport indicating the time during which a user can stay at the airport based on the arrival time and the scheduled boarding time. The notification unit 33 calculates a travel time from the inspection area to the scheduled boarding place. The notification unit 33 calculates a time obtained by subtracting the arrival time and the travel time from the scheduled boarding time as an allowable time of staying at the airport.

When the procedure time estimated by the time estimation unit 31 is equal to or longer than the allowable time of staying at the airport, the notification unit 33 provides a notification prompting a user to move to the inspection area since the user may not be able to meet the scheduled boarding time.

For example, the notification unit 33 notifies a user of the message “The scheduled boarding time is approaching. Please go to the security checkpoint”. When the information processing apparatus 30 is a communication terminal, the notification unit 33 displays the aforementioned message on the communication terminal. Further, when the information processing apparatus 30 is a personal computer apparatus, a server apparatus, or the like, the notification unit 33 notifies the communication terminal owned by a user that the aforementioned message will be displayed.

The notification unit 33 may distribute, to the user, privilege information (a coupon) of the store located in the boarding area after the inspection area is passed through in addition to a notification prompting the user to move to the inspection area.

When the procedure time estimated by the time estimation unit 31 is less than the allowable time of staying at the airport, the notification unit 33 distributes, to a user, privilege information (a coupon) of the store located in the area before the inspection area is passed through. For example, the notification unit 33 may distribute a coupon of the store located in the check-in area before the inspection area of the airport is passed through or may distribute a coupon of the store located in the facility near the airport.

When the procedure time estimated by the time estimation unit 31 is less than the allowable time of staying at the airport, the notification unit 33 calculates a time difference between the procedure time and the allowable time of staying at the airport. The notification unit 33 determines a coupon to be distributed to a user based on the calculated time difference and distributes the determined coupon. For example, the notification unit 33 may determine the money amount of the coupon to be distributed in accordance with the time difference or may determine the number of coupons to be distributed in accordance with the time difference.

The notification unit 33 may determine a coupon to be distributed from the coupons acquired and stored in advance and may distribute the determined coupon to a user. Alternatively, the notification unit 33 may acquire a coupon to be distributed from a server apparatus in which the coupon that can be used at the store in the airport is stored and may distribute the acquired coupon.

<Operation Example of Information Processing Apparatus>

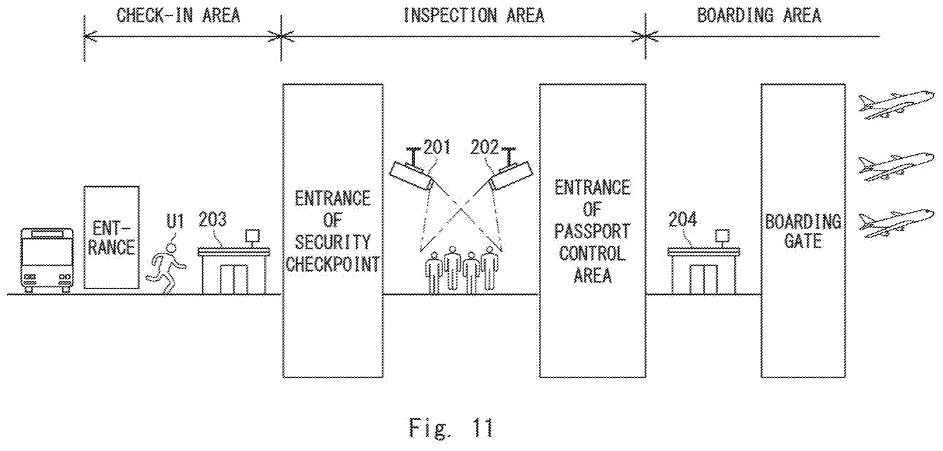

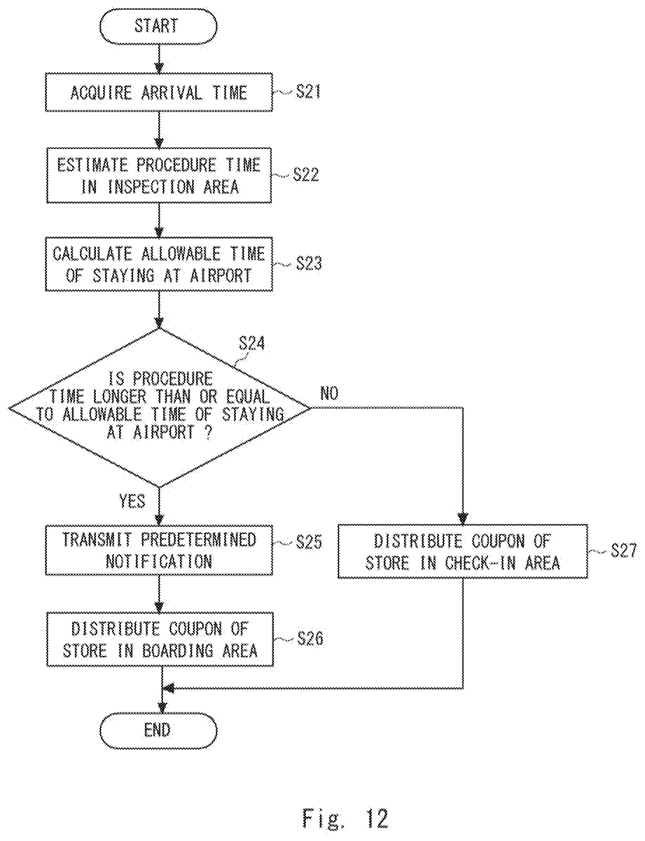

Next, an operation example of the information processing apparatus 30 according to the fourth example embodiment is described with reference to FIGS. 11 and 12. FIG. 11 is a diagram for explaining an outline of the operation example of the information processing apparatus according to the fourth example embodiment. FIG. 12 is a flowchart showing the operation example of the information processing apparatus according to the fourth example embodiment.

First, FIG. 11 is described. FIG. 11 is a diagram schematically showing the airport including the scheduled boarding place of the aircraft which a user plans to board. As shown in FIG. 11, the airport facility includes three main areas.

A first area is an inspection area, and the inspection area is an area including the security checkpoint and the passport control area and is an area which extends from the entrance of the security checkpoint to the exit of the passport control area. In the inspection area, a camera 201 as an image-pickup apparatus and a sensor 202 are installed. The camera 201 takes an image of the procedure gate located in the inspection area and generates image data. The sensor 202 generates sensing data obtained by sensing the procedure gate. Note that the inspection area may be an area of the security checkpoint site or may be an area which extends from the entrance of the security checkpoint to the exit thereof.

A second area is an area before the inspection area is passed through and is a check-in area. A store 203 is located in the check-in area. Note that the second area may include the area of the facility near the airport shown in FIG. 11. A third area is an area after the inspection area is passed through and is a boarding area. A store 204 is located in the boarding area.

First, when a user UI arrives at the airport, the acquisition unit 32 acquires the arrival time. Further, the time estimation unit 31 acquires image data from the camera 201. The time estimation unit 31 acquires sensing data from the sensor 202. The time estimation unit 31 calculates the number of waiting people based on the image data. The time estimation unit 31 calculates the throughput of the procedure gate based on the sensing data. The time estimation unit 31 estimates the procedure time required for the procedure in the inspection area using the number of waiting people and the throughput.

The notification unit 33 calculates an allowable time of staying at the airport indicating the time during which the user UI can stay at the airport based on the arrival time and the scheduled boarding time. The notification unit 33 calculates a travel time from the inspection area to the scheduled boarding place. The notification unit 33 calculates a time obtained by subtracting the arrival time and the travel time from the scheduled boarding time as an allowable time of staying at the airport.

When the procedure time estimated by the time estimation unit 31 is equal to or longer than the allowable time of staying at the airport, the notification unit 33 provides a notification prompting the user UI to move to the inspection area. Further, the notification unit 33 may distribute a coupon of the store 204 to the user UI.

When the procedure time estimated by the time estimation unit 31 is less than the allowable time of staying at the airport, the notification unit 33 distributes a coupon of the store 203 to the user UI. The notification unit 33 calculates a time difference between the procedure time and the allowable time of staying at the airport. The notification unit 33 determines a coupon to be distributed to the user UI based on the calculated time difference and distributes the determined coupon.

Next, FIG. 12 is described. FIG. 12 is a flowchart showing an operation example of the information processing apparatus 30 according to the fourth example embodiment. FIG. 12 shows an operation example performed when a user arrives at the airport after the operation shown in FIG. 6 is performed.

When a user arrives at the airport, the acquisition unit 32 acquires the arrival time (Step S21). The acquisition unit 32 notifies the notification unit 33 of the acquired arrival time.

The time estimation unit 31 estimates a procedure time required for the procedures in the inspection area of the airport (Step S22). The time estimation unit 31 acquires image data obtained by the image-pickup apparatus taking the image of the inspection area. Further, the time estimation unit 31 acquires sensing data acquired by the sensor. The time estimation unit 31 calculates the number of waiting people based on the image data. The time estimation unit 31 calculates a throughput indicating the number of people who pass through the procedure gate per unit time based on the sensing data.

The time estimation unit 31 estimates the procedure time required for the procedure in the inspection area using the number of waiting people and the throughput. The time estimation unit 31 transmits the estimated procedure time to the notification unit 33. Note that Step S22 may be performed after Step S21 or may be performed periodically or aperiodically before Step S21.

The notification unit 33 calculates an allowable time of staying at the airport indicating the time during which the user can stay at the airport based on the arrival time and the scheduled boarding time (Step S23). The notification unit 33 calculates a travel time from the inspection area to the scheduled boarding place. The notification unit 33 calculates a time obtained by subtracting the arrival time and the travel time from the scheduled boarding time as an allowable time of staying at the airport.

The notification unit 33 determines whether the procedure time is equal to or longer than the allowable time of staying at the airport (Step S24).

When the procedure time is equal to or longer than the allowable time of staying at the airport (YES in Step S24), the notification unit 33 transmits a predetermined notification to the user (Step S25). The predetermined notification is a notification that prompts the user to move to the inspection area and notifies the user of the message “The scheduled boarding time is approaching. Please go to the security checkpoint”.

The notification unit 33 distributes a coupon of the store in the boarding area to the user (Step S26). The notification unit 33 distributes a coupon that can be used in the store arranged in the boarding area to the user for moving the user to the inspection area. Note that Step S26 may not be performed.

On the other hand, when the procedure time is less than the allowable time of staying at the airport (NO in Step S24), the notification unit 33 distributes a coupon of the store in the check-in area (Step S27). The notification unit 33 calculates a time difference between the procedure time and the allowable time of staying at the airport. The notification unit 33 determines a coupon to be distributed to the user based on the calculated time difference and distributes the determined coupon.

As described above, the acquisition unit 32 acquires the arrival time at which a user arrives at the airport. The time estimation unit 31 estimates a procedure time required for the procedures in the inspection area. The notification unit 33 calculates an allowable time of staying at the airport based on the arrival time and the scheduled boarding time and determines whether the user needs to move to the inspection area based on the procedure time and the allowable time of staying at the airport. When the user needs to move to the inspection area, the notification unit 33 provides a notification prompting the user to move to the inspection area. Further, when the user needs to move to the inspection area, the notification unit 33 distributes a coupon of the store in the boarding area after the inspection area is passed through and prompts the user to move to the inspection area.

On the other hand, when the user does not need to move to the inspection area, the notification unit 33 distributes a coupon of the store in the check-in area before the inspection area is passed through to the user. As described above, among users who have arrived at the airport, the information processing apparatus 30 guides, to the inspection area, the user who immediately needs the procedure in the inspection area and prompts the user who does not immediately need the procedure in the inspection area to do shopping using a coupon. That is, the information processing apparatus 30 according to the fourth example embodiment prevents a user who does not immediately need the procedure in the examination area from travelling to the inspection area. Therefore, the information processing apparatus 30 according to the fourth example embodiment makes it possible to contribute to relief from the congestion in the airport facility.

Further, as described above, the notification unit 33 prompts a user who does not immediately need the procedure in the inspection area to do shopping using a coupon. Therefore, the information processing apparatus 30 according to the fourth example embodiment makes it possible to contribute to sales at the stores in the airport facility and to contribute to the enhancement of economic effects in the airport facility.

### Other Example Embodiments

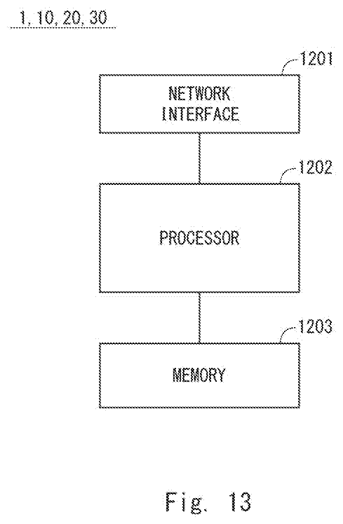

The information processing apparatuses 1, 10, 20, and 30 (hereinafter, referred to as the information processing apparatus 1 and the like) described in the above example embodiments may each have the following hardware configuration. FIG. 13 is a block diagram showing a hardware configuration of the information processing apparatus and the like according to the example embodiments of the present disclosure.

Referring to FIG. 13, the information processing apparatus 1 and the like each include a network interface 1201, a processor 1202, and a memory 1203. The network interface 1201 is used to communicate with another communication apparatus having a communication function. The network interface 1201 may include, for example, a network interface card (NIC) in conformity with a communication system including IEEE (Institute of Electrical and Electronics Engineers) 802.11 series, IEEE 802.3 series, and the like.

The processor 1202 loads software (computer programs) from the memory 1203 and executes the software to perform the processing of the information processing apparatus 1 and the like described with reference to the flowchart in the above-described example embodiments. The processor 1202 may be, for example, a microprocessor, a Micro Processing Unit (MPU), or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an I/O interface (not shown).

In the example shown in FIG. 13, the memory 1203 is used to store software modules. The processor 1202 can load these software modules from the memory 1203 and execute the loaded software modules, thereby performing the information processing apparatus 1 and the like described in the above-described example embodiments.

As described with reference to FIG. 13, each of the processors included in the information processing apparatus 1 and the like executes one or a plurality of programs including instructions to cause a computer to perform an algorithm described with reference to the drawings.

In the above examples, the program(s) can be stored and provided to a computer using any type of non-transitory computer readable media. Non-transitory computer readable media include any type of tangible storage media. Examples of non-transitory computer readable media include magnetic storage media (e.g., flexible disks, magnetic tapes, and hard disk drives), optical magnetic storage media (e.g., magneto-optical disks). Further, examples of non-transitory computer readable media include CD-ROM (Read Only Memory), CD-R, and CD-R/W. Further, examples of non-transitory computer readable media include semiconductor memories. The semiconductor memories include, for example, mask ROM, PROM (Programmable ROM), EPROM (Erasable PROM), flash ROM, RAM (Random Access Memory), etc. Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and can be modified as appropriate without departing from the spirit of the present disclosure. Further, the present disclosure may be executed by combining the example embodiments as appropriate.

Further, the whole or part of the example embodiments disclosed above can be described as, but not limited to, the following supplementary notes.

(Supplementary Note 1)

An information processing apparatus comprising:

an acquisition unit configured to acquire a position of a user and reservation information of an aircraft which the user plans to board;

a calculation unit configured to calculate, based on the reservation information, a travel time including a spare time for a scheduled boarding time of the aircraft corresponding to a mode of transportation and a travel route from the position to a scheduled boarding place of the aircraft; and

a notification unit configured to notify the user of the travel time corresponding to the mode of transportation and the travel route.

(Supplementary Note 2)

The information processing apparatus described in Supplementary Note 1, wherein the calculation unit calculates a safety coefficient corresponding to the mode of transportation and the travel route based on detour route information about a detour route for each combination of the mode of transportation and the travel route and first delay information about a delay that has occurred in the past for each combination of the mode of transportation and the travel route, and calculates the spare time corresponding to the mode of transportation and the travel route based on the safety coefficient.

(Supplementary Note 3)

The information processing apparatus described in Supplementary Note 2, wherein the calculation unit calculates, based on the detour route information and the first delay information, a first degree of reliability based on a potential risk corresponding to the mode of transportation and the travel route, and a second degree of reliability based on a degree of influence that a delay corresponding to the mode of transportation and the travel route has when the delay occurs, and calculates the safety coefficient corresponding to the mode of transportation and the travel route by using the first degree of reliability and the second degree of reliability.

(Supplementary Note 4)

The information processing apparatus described in Supplementary Note 3, wherein

the first delay information includes a frequency of occurrence of delay and an index value indicating a variation in delay time, and

the calculation unit calculates the first degree of reliability based on the detour route information and the frequency of occurrence and calculates the second degree of reliability based on the detour route information and the index value.

(Supplementary Note 5)

The information processing apparatus described in any one of

Supplementary Notes 2 to 4, wherein

the acquisition unit acquires second delay information about a delay predicted to occur by the scheduled boarding time for each combination of the mode of transportation and the travel route, and

the calculation unit corrects the travel time corresponding to the mode of transportation and the travel route based on the second delay information.

(Supplementary Note 6)

The information processing apparatus described in any one of Supplementary Notes 1 to 5, further comprising an action estimation unit configured to estimate an action characteristic of the user based on an action history of the user, wherein

the calculation unit corrects the spare time corresponding to the mode of transportation and the travel route based on the action characteristic.

(Supplementary Note 7)

The information processing apparatus described in Supplementary Note 6, wherein

the action estimation unit estimates a mode of transportation predicted to be selected by the user based on the action history,

the calculation unit calculates the travel time corresponding to the estimated mode of transportation, and

the notification unit notifies the user of the estimated mode of transportation and the travel time corresponding to the estimated mode of transportation.

(Supplementary Note 8)

The information processing apparatus described in any one of Supplementary Notes 1 to 7, wherein

the acquisition unit acquires an arrival time at which the user arrives at an airport including the scheduled boarding place,

the information processing apparatus further comprises a time estimation unit configured to estimate a procedure time required for a procedure in a first area of the airport, and

the notification unit calculates, based on the arrival time and the scheduled boarding time, an allowable time of staying indicating a time during which the user can stay at the airport and provides a notification prompting the user to move to the first area when the procedure time is equal to or longer than the allowable time of staying.

(Supplementary Note 9)

The information processing apparatus described in Supplementary Note 8, wherein

when the procedure time is equal to or longer than the allowable time of staying, the notification unit distributes, to the user, first privilege information of a store located in a second area after the first area is passed through.

(Supplementary Note 10)

The information processing apparatus described in Supplementary Note 8 or 9, wherein when the procedure time is less than the allowable time of staying, the notification unit distributes second privilege information of a store located in a third area before the first area is passed through.

(Supplementary Note 11)

The information processing apparatus described in Supplementary Note 10, wherein when the procedure time is less than the allowable time of staying, the notification unit calculates a time difference between the procedure time and the allowable time of staying and distributes the second privilege information in accordance with the time difference.

(Supplementary Note 12)

The information processing apparatus described in any one of Supplementary Notes 8 to 11, wherein the time estimation unit calculates the number of waiting people based on the image data obtained by taking an image of the first area, calculates a throughput indicating the number of people who pass through a procedure gate per unit time based on sensing data acquired by a sensor located in the first area, and estimates the procedure time using the number of waiting people and the throughput.

(Supplementary Note 13)

The information processing apparatus described in any one of Supplementary Notes 8 to 12, wherein the first area is an area including at least one of a security checkpoint and a passport control area.

(Supplementary Note 14)

A notification method comprising:

acquiring a position of a user and reservation information of an aircraft which the user plans to board;

calculating, based on the reservation information, a travel time including a spare time for a scheduled boarding time of the aircraft corresponding to transportation and a travel route from the position to a scheduled boarding place of the aircraft; and

notifying the user of the travel time corresponding to the mode of transportation and the travel route.

(Supplementary Note 15)

A program for causing a computer to:

acquire a position of a user and reservation information of an aircraft which the user plans to board;

calculate, based on the reservation information, a travel time including a spare time for a scheduled boarding time of the aircraft corresponding to a mode of transportation and a travel route from the position to a scheduled boarding place of the aircraft; and

notify the user of the travel time corresponding to the mode of transportation and the travel route.

According to the present disclosure, it is possible to provide an information processing apparatus, a notification method, and a computer readable medium that can contribute to relief from congestion in an airport facility.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An information processing apparatus comprising:
an acquisition unit configured to acquire a position of a user and reservation information of an aircraft which the user plans to board;
a calculation unit configured to calculate, based on the reservation information, a travel time including a spare time for a scheduled boarding time of the aircraft corresponding to a mode of transportation and a travel route from the position to a scheduled boarding place of the aircraft; and
a notification unit configured to notify the user of the travel time corresponding to the mode of transportation and the travel route.

2. The information processing apparatus according to claim 1, wherein the calculation unit calculates a safety coefficient corresponding to the mode of transportation and the travel route based on detour route information about a detour route for each combination of the mode of transportation and the travel route and first delay information about a delay that has occurred in the past for each combination of the mode of transportation and the travel route, and calculates the spare time corresponding to the mode of transportation and the travel route based on the safety coefficient.

3. The information processing apparatus according to claim 2, wherein the calculation unit calculates, based on the detour route information and the first delay information, a first degree of reliability based on a potential risk corresponding to the mode of transportation and the travel route, and a second degree of reliability based on a degree of influence that a delay corresponding to the mode of transportation and the travel route has when the delay occurs, and calculates the safety coefficient corresponding to the mode of transportation and the travel route by using the first degree of reliability and the second degree of reliability.

4. The information processing apparatus according to claim 3, wherein
the first delay information includes a frequency of occurrence of delay and an index value indicating a variation in delay time, and
the calculation unit calculates the first degree of reliability based on the detour route information and the frequency of occurrence and calculates the second degree of reliability based on the detour route information and the index value.

5. The information processing apparatus according to claim 2, wherein
the acquisition unit acquires second delay information about a delay predicted to occur by the scheduled boarding time for each combination of the mode of transportation and the travel route, and
the calculation unit corrects the travel time corresponding to the mode of transportation and the travel route based on the second delay information.

6. The information processing apparatus according to claim 1, further comprising an action estimation unit configured to estimate an action characteristic of the user based on an action history of the user, wherein
the calculation unit corrects the spare time corresponding to the mode of transportation and the travel route based on the action characteristic.

7. The information processing apparatus according to claim 6, wherein
the action estimation unit estimates a mode of transportation predicted to be selected by the user based on the action history,
the calculation unit calculates the travel time corresponding to the estimated mode of transportation, and
the notification unit notifies the user of the estimated mode of transportation and the travel time corresponding to the estimated mode of transportation.

8. The information processing apparatus according to claim 1, wherein
the acquisition unit acquires an arrival time at which the user arrives at an airport including the scheduled boarding place,
the information processing apparatus further comprises a time estimation unit configured to estimate a procedure time required for a procedure in a first area of the airport, and
the notification unit calculates, based on the arrival time and the scheduled boarding time, an allowable time of staying indicating a time during which the user can stay at the airport and provides a notification prompting the user to move to the first area when the procedure time is equal to or longer than the allowable time of staying.

9. The information processing apparatus according to claim 8, wherein when the procedure time is equal to or longer than the allowable time of staying, the notification unit distributes, to the user, first privilege information of a store located in a second area after the first area is passed through.

10. The information processing apparatus according to claim 8, wherein when the procedure time is less than the allowable time of staying, the notification unit distributes second privilege information of a store located in a third area before the first area is passed through.

11. The information processing apparatus according to claim 10, wherein when the procedure time is less than the allowable time of staying, the notification unit calculates a time difference between the procedure time and the allowable time of staying and distributes the second privilege information in accordance with the time difference.

12. The information processing apparatus according to claim 8, wherein the time estimation unit calculates the number of waiting people based on the image data obtained by taking an image of the first area, calculates a throughput indicating the number of people who pass through a procedure gate per unit time based on sensing data acquired by a sensor located in the first area, and estimates the procedure time using the number of waiting people and the throughput.

13. The information processing apparatus according to claim 8, wherein the first area is an area including at least one of a security checkpoint and a passport control area.

14. A notification method comprising:
acquiring a position of a user and reservation information of an aircraft which the user plans to board;
calculating, based on the reservation information, a travel time including a spare time for a scheduled boarding time of the aircraft corresponding to transportation and a travel route from the position to a scheduled boarding place of the aircraft; and
notifying the user of the travel time corresponding to the mode of transportation and the travel route.

15. A non-transitory computer readable medium storing a program for causing a computer to:
acquire a position of a user and reservation information of an aircraft which the user plans to board;
calculate, based on the reservation information, a travel time including a spare time for a scheduled boarding time of the aircraft corresponding to a mode of transportation and a travel route from the position to a scheduled boarding place of the aircraft; and
notify the user of the travel time corresponding to the mode of transportation and the travel route.
